(19) United States
(12) Patent Application Publication
(10) Pub. No.: US 2015/0261735 A1
(43) Pub. Date: Sep. 17, 2015

(54) DOCUMENT PROCESSING SYSTEM, DOCUMENT PROCESSING APPARATUS, AND DOCUMENT PROCESSING METHOD

(71) Applicant: Yoshihisa OHGURO, Kanagawa (JP)

(72) Inventor: Yoshihisa OHGURO, Kanagawa (JP)

(73) Assignee: Ricoh Company, Ltd., Tokyo (JP)

(21) Appl. No.: 14/644,752

(22) Filed: Mar. 11, 2015

(30) Foreign Application Priority Data
Mar. 12, 2014 (JP) 2014-048663
Feb. 27, 2015 (JP) 2015-037577

(51) Int. Cl. G06F 17/24; G06K 9/00; G06F 17/30; G06F 17/21

(52) U.S. Cl. CPC G06F 17/243; G06F 17/211; G06K 9/00469; G06F 17/30696

(57) ABSTRACT

A document processing system includes a document storage unit storing document images which include a predetermined one or more character strings and one or more fill-in ranges which correspond to the one or more character strings; an association information storage unit storing the character strings of the document images in association with the fill-in ranges corresponding to the character strings; a searching for unit searching for a character string, which includes a requested searched-for character string, from among the stored character strings; and a display control unit displaying a list of images of the fill-in ranges corresponding to the searched for character string of the stored document images.

### CROSS-REFERENCE TO RELATED APPLICATIONS

The present application is based on and claims the benefit of priority under 35 U.S.C §119 of Japanese Patent Application No. 2014-048663 filed Mar. 12, 2014, and 2015-037577 filed Feb. 27, 2015, the entire contents of which are hereby incorporated herein by reference.

### BACKGROUND OF THE INVENTION

1. Field of the Invention

The present invention generally relates to a document processing system, a document processing apparatus, and a document processing method.

2. Description of the Related Art

There is a known document management apparatus which recognizes and searches for hand-written characters (letters) which are written on a document having a predetermined format such as, for example, a ledger paper, an interview paper, etc. Further, there is known a document management apparatus which separates document image data, where typed characters (letters) and hand-written characters are mixed, into image data of a typed area and image area of a hand-written area, performs a character recognition process on each of the areas, and generates index tables to be searched (see, for example, Japanese Laid-open Patent Publication No. 2007-011683).

### SUMMARY OF THE INVENTION

According to an aspect of the present invention, a document processing system includes a document storage (accumulation) unit storing (accumulating) document images which include a predetermined one or more character strings and one or more fill-in ranges which correspond to the one or more character strings; an association information storage unit storing the character strings of the document images in association with the fill-in ranges corresponding to the character strings; a searching for unit searching for a character string, which includes a requested searched-for character string, from among the stored character strings; and a display control unit displaying a list of images of the fill-in ranges corresponding to the searched for character string of the stored (accumulated) document images.

### BRIEF DESCRIPTION OF THE DRAWINGS

Other objects, features, and advantages of the present invention will become more apparent from the following description when read in conjunction with the accompanying drawings, in which:

FIG. 1 illustrates an example configuration of a document processing system according to an embodiment;

FIG. 2 illustrates an example hardware configuration of a computer according to an embodiment;

FIG. 3 illustrates an example hardware configuration of an image forming apparatus according to an embodiment;

FIG. 4 illustrates an example functional configuration of the document processing system according to an embodiment;

FIG. 5 illustrates an example document according to an embodiment;

FIG. 6 is an enlarged view of the example document according to an embodiment;

FIGS. 7A and 7B illustrate an OCR process according to an embodiment;

FIG. 8 illustrates a process of identifying a fill-in range according to an embodiment;

FIG. 9 illustrates an example template according to an embodiment;

FIG. 10 is a flowchart of an example template registration process according to an embodiment;

FIG. 11 is a flowchart of an example storage (accumulation) process on document information according to an embodiment;

FIG. 12 is a flowchart of an example document display process according to an embodiment;

FIG. 13 is a sequence diagram of an example storage process of the document information according to an embodiment;

FIG. 14 is a sequence diagram of an example searching for process of the document information according to an embodiment;

FIGS. 15A and 15B illustrate example input screens to input a searched-for word according to an embodiment;

FIG. 16 illustrates an example display screen of an image list according to an embodiment; and

FIG. 17 illustrates an example display screen of a document image according to an embodiment.

### DETAILED DESCRIPTION OF THE PREFERRED EMBODIMENTS

Basically, it is possible to accurately recognize typed text (no handwriting) because the character figures are stable, but it is difficult to accurately recognize hand-written text because of individual difference and unstable figures. Further, in order to increase the recognition accuracy of hand-written text, there is a known method in which a person (writer) is requested to write one character in one block (characters are written on a block basis). However, if it is requested to write a long sentence into a ledger paper dedicated to handwriting where each character is to be written into block by block, the person does not like to write that way because usability (convenience) is remarkably lowered. Therefore, such a writing method is not generally used.

On the other hand, in a ledger paper and an interview paper, it is possible to accurately recognize choices which are selected by a person by identifying the columns which are filled with a writing material such as a pencil by using an Optical Mark Recognition (OMR) technique for questions with choices. However, even in such a case, if there is a part where handwriting is necessary to, for example, write a text answer which is not included in the choices, it is still difficult to recognize such text, so that, for example, it is necessary for an operator to read and type the texts (by using a keyboard) to digitize the text.

As described, it is difficult to digitize and use a document which includes handwritten texts written on a predetermined format.

The present invention is made in light of the above problem, and may provide a document processing system that digitizes a document which includes handwritten texts written on a predetermined format so that the document can be used (handled) easily.

In the following, embodiments of the present invention are described with reference to the accompanying drawings.

### System Configuration

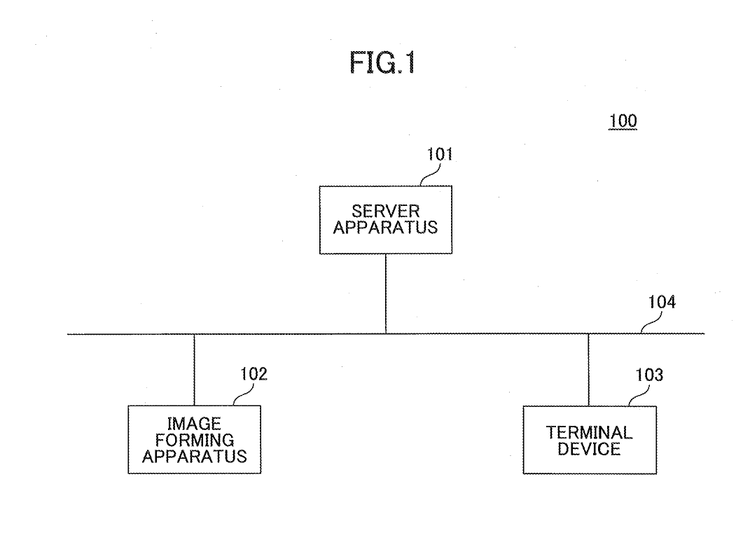

FIG. 1 illustrates an example configuration of a document processing system according to an embodiment. A document processing system 100 includes a server apparatus 101 (an example of a “document processing apparatus”), an image forming apparatus 102 (another example of the “document processing apparatus”), and a terminal device 103 (still another example of the “document processing apparatus”), which are connected to each other via a network 104 such as, for example, the Internet, a Local Area Network (LAN), etc.

The server apparatus 101 refers to an information processing apparatus having a configuration of a general computer, and is an example of a document management apparatus according to an embodiment. Various functions as the document management apparatus are realized by a program, etc., which runs on the server apparatus 101. The image forming apparatus 102 refers to an apparatus having an image reading function of, for example, a multifunctional peripheral having the functions of a printer, a scanner, a copier, a facsimile machine, etc., in a single chassis. The terminal device 103 refers to an information processing apparatus having a configuration of a general computer such as a Personal Computer (PC), a tablet terminal, a smartphone, etc.

In the configuration of FIG. 1, a user, who will register a document image in the document processing system 100, reads an image of a document (document image) to be registered in the document processing system 100 by using, for example, the image forming apparatus 102, and stores (accumulates) the read document image in the server apparatus 101. Further, a user, who will browse the document image stored in the server apparatus 101, uses the terminal device 103 to input, for example, a searched-for character string and checks the search result on a display screen of the terminal device 103, etc.

Note that the configuration of FIG. 1 is one example only. For example, a program which realizes the functions of the document management apparatus may be installed in the image forming apparatus 102, terminal device 103, etc. Namely, the image forming apparatus 102, terminal device 103, etc. may serve as the document management apparatus. Further, the image forming apparatus 102 may be a scanning device, etc., which is connected to the server apparatus 101, the terminal device 103, etc. Further, the various functions of the document management apparatus may be distributed in plural server apparatuses 101, etc.

### Hardware Configuration

### Server Apparatus 101 and Terminal Device 103

The server apparatus 101 and the terminal device 103 have a configuration of, for example, a general computer.

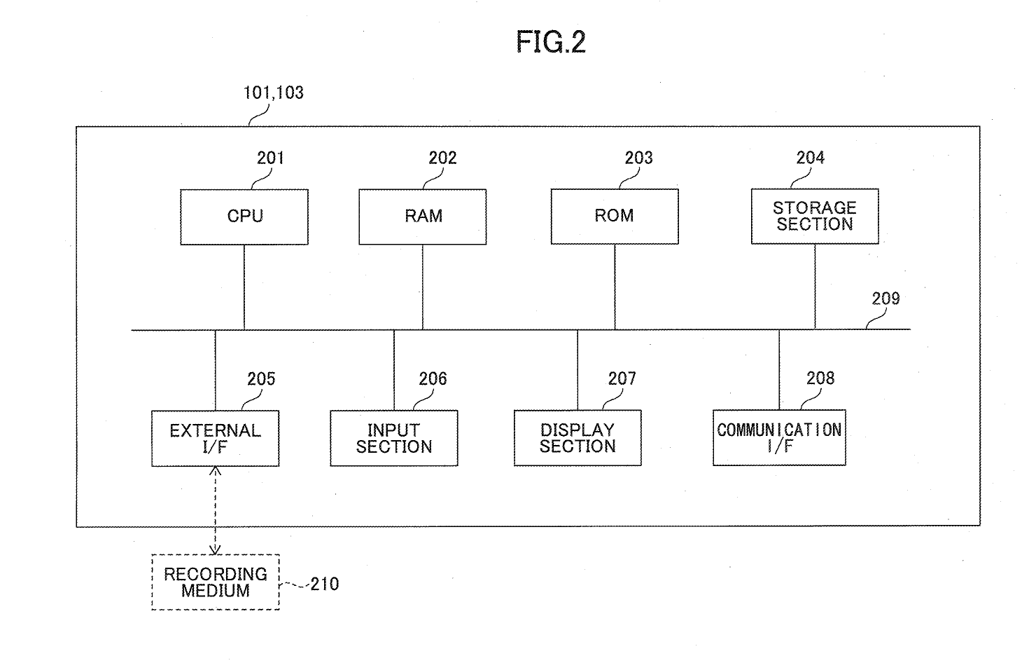

FIG. 2 illustrates an example hardware configuration of a computer according to an embodiment. The server apparatus 101 and the terminal device 103 include, for example, a Central Processing Unit (CPU) 201, a Random Access Memory (RAM) 202, a Read-Only Memory (ROM) 203, a storage section 204, an external interface (I/F) 205, an input section 206, a display section 207, a communication I/F 208, a bus 209, etc.

The CPU 201 refers to an arithmetic device (processor) which realizes the functions of the server apparatus 101 or the terminal device 103 by reading (loading) a program and data, which are stored in the ROM 203 and the storage section 204, on the RAM 202 and executing the program (processes). The RAM 202 refers to a volatile memory which is used as, for example, a work area of the CPU 201. The ROM 203 refers to a non-volatile memory which can hold the program and data stored therein even when power thereto is turned off, and may be, for example, a flash ROM.

The storage section 204 refers to a storage device such as a Hard Disk Drive (HDD), a Solid State Device (SSD), etc., and stores an application program, various data, etc.

The external I/F 205 refers to an interface with an external device. The external device may be, for example, a recording medium 210. The server apparatus 101 and the terminal device 103 can read and write data from and to the recording medium 210. The recording medium 210 may be, for example, an optical disk, a magnetic disk, a memory card, a Universal Serial Bus (USB) memory, etc.

Further, by storing a predetermined program in the recording medium 210 and installing the program into the server apparatus 101 or the terminal device 103 via the external I/F 205, it become possible to execute the predetermined program.

The input section 206 includes, for example, a pointing device such as a mouse, a keyboard, etc., and is used to input various operation signals to the server apparatus 101 or the terminal device 103. The display section 207 includes a display, etc., and displays a result of processing performed by the server apparatus 101 or the terminal device 103.

The communication I/F 208 refers to an interface so that the server apparatus 101 or the terminal device 103 is connected to the network 104. By having the communication I/F 208, it becomes possible for the server apparatus 101 or the terminal device 103 to perform data communications with another apparatus (device) via the network 104. The bus 209 is connected to the elements described above, and transmits address signals, data signals, various control signals, etc.

Note that the configuration of FIG. 2 is one example only. For example, the input section 206, the display section 207, etc., of the server apparatus 101 or the terminal device 103 may be provided outside of the server apparatus 101 or the terminal device 103, respectively. Further, for example, the server apparatus 101 or the terminal device 103 may include a touch panel display which includes the input section 206 and the display section 207.

### Image Forming Apparatus

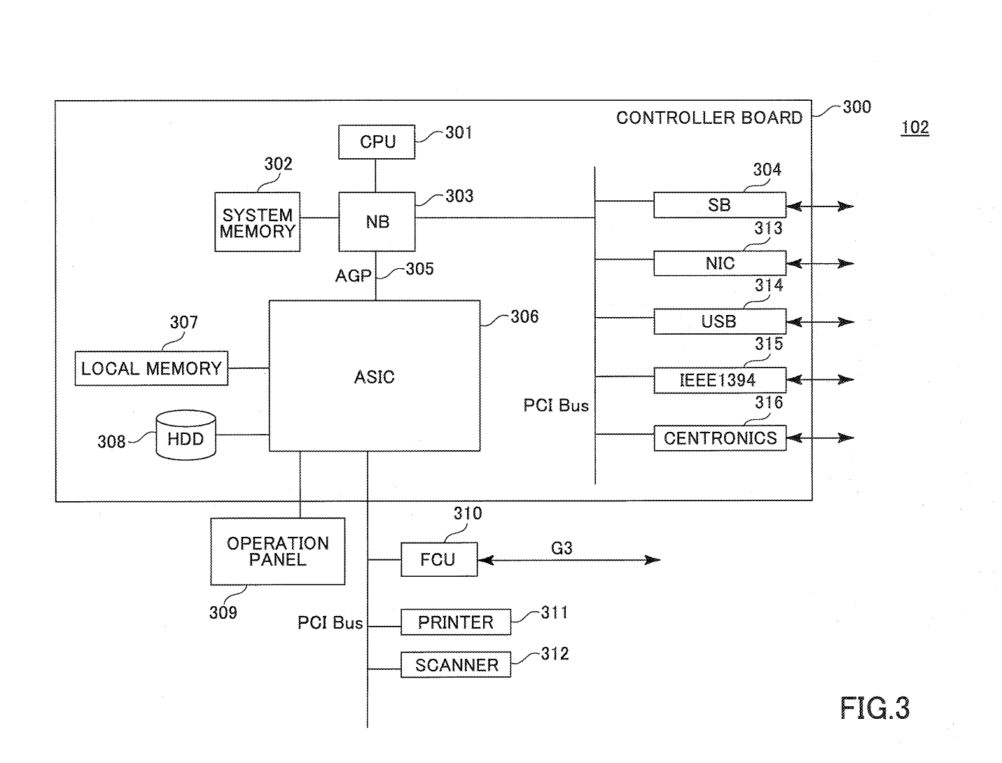

FIG. 3 illustrates an example hardware configuration of an image forming apparatus according to an embodiment. The image forming apparatus 102 includes, for example, a controller board 300, an operation panel 309, a Facsimile Control Unit (FCU) 310, and a hardware engine such as a printer 311, a scanner 312, etc.

The controller board 300 includes a configuration of a general computer. Namely, the controller board 300 includes a CPU 301, a system memory 302, a North Bridge (NB) 303, a South Bridge (SB) 304, an Application Specific Integrated Circuit (ASIC) 306, a local memory 307, an HDD 308, a Network Interface Card (NIC) 313, a USB interface 314, an IEEE1394 interface 315, a Centronics interface 316, etc.

The operation panel 309 is connected to the ASIC 306 of the controller board 300. Further, the SB 304, the NIC 313, the USB interface 314, the IEEE1394 interface 315, and the Centronics interface 316 are connected to the NB 303 via a PCI bus. Further, the FCU 310, the printer 311, and the scanner 312 are connected to the ASIC 306 of the controller board 300 via a PCI bus.

Further, the ASIC 306 of the controller board 300 is connected to the local memory 307, the HDD 308, etc. Further, the CPU 301 is connected to the ASIC 306 via the NB 303 of a CPU chipset. Further, for high-speed communications, the ASIC 306 is connected to the NB 303 via not a PCI bus but an accelerated Graphics Port (AGP) 305.

The CPU 301 is a processor that performs overall control of the image forming apparatus 102. The CPU 301 executes the operating system, an application, and a program providing various services stored, for example, the HDD 308, etc., so as to realize the functions of the image forming apparatus 102.

The NB 303 is a bridge to connect the CPU 301, the system memory 302, the SB 304, and the ASIC 306 to each other. The system memory 302 is a memory to be used, for example, as a drawing memory of the image forming apparatus 102. The SB 304 is a bridge to connect the NB 303 to the PCI bus and peripheral devices. Further, the local memory 307 is a memory to be used, for example, as a copy image buffer and a code buffer. Hereinafter the system memory 302 and the local memory 307 may be referred to (simplified) as a “memory” or a “storage area”.

ASIC 306 is an integrated circuit dedicated to an image processing and having a hardware element for the image processing. The HDD 308 is a storage device to store (accumulate), for example, an image, a program, a font data, a form, etc.

Further, the operation panel 309 is hardware to receive an input operation by a user (operation section) and is hardware to display for the user (display section). The FCU 310 performs transmission and reception of FAX data in accordance with a standard such as, for example, Group 3 Facsimile (G3 FAX). The printer 311 performs printing, for example, under the control of the program running in the CPU 301.

The NIC 313 is a communication interface to connect the image forming apparatus 102 to the network 104 so as to perform data transmission and reception. The USB interface 314 is a serial bus interface to connect the image forming apparatus 102 to, for example, a recording medium such as a USB memory and various USB-based devices. The IEEE1394 interface 315 is an interface to connect the image forming apparatus 102 to, for example, a device in compliance with IEEE1394, which is a high-speed serial bus standard. The Centronics interface 316 is an interface to connect the image forming apparatus 102 to, for example, a device in compliance with Centronics specification, which is a parallel port specification.

Note that the configuration of FIG. 3 is one example only. For example, the image forming apparatus 102 may be a copier without the facsimile function, a scanner without the printing function, etc.

### Functional Configuration

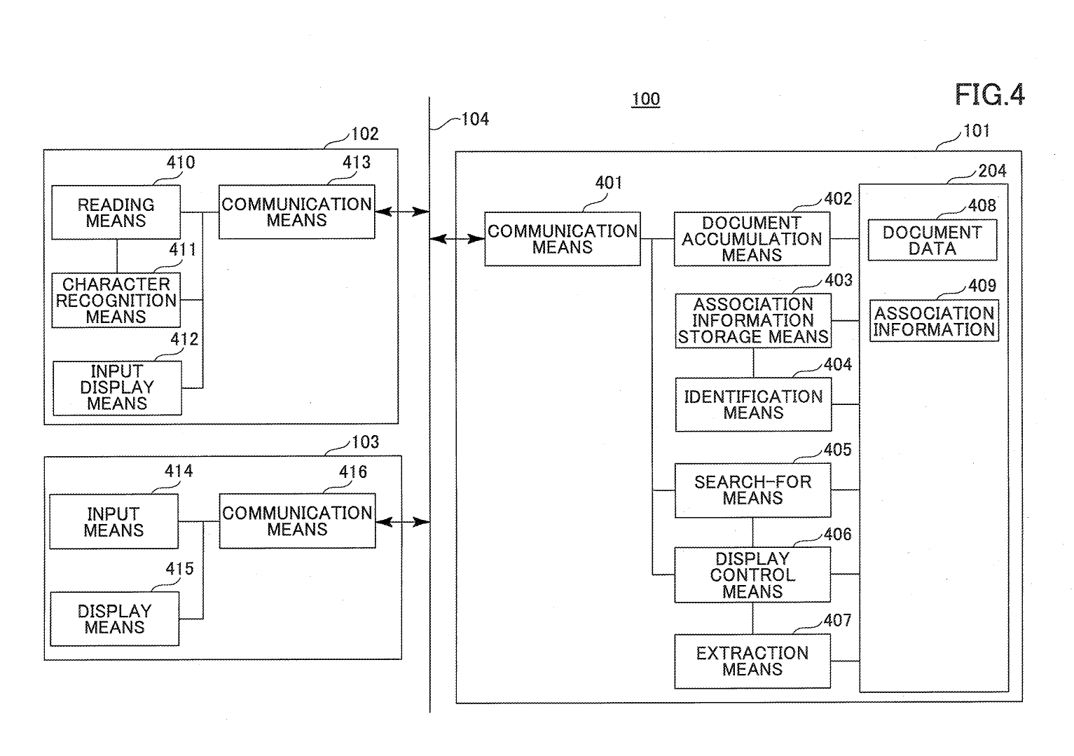

FIG. 4 illustrates an example functional configuration of the document processing system according to an embodiment.

### Functional Configuration of the Server Apparatus 101

In FIG. 4, the server apparatus (document processing apparatus) 101 includes, for example, a communication means 401, a document storage means 402, an association information storage means 403, an identification means 404, a search-for means 405, a display control means 406, and an extraction means 407.

The communication means 401 is a means for connecting the server apparatus 101 to the network 104 so as to perform data transmission and reception with the image forming apparatus 102, the terminal device 103, etc., and corresponds to, for example, the communication I/F 208 of FIG. 2.

The document storage (accumulation) means 402 stores (accumulates) an image of document (document image) which includes a predetermined one or more character strings, and fill-in ranges (entry ranges) corresponding to the character strings. The document storage means 402 stores (accumulates) the document image, which is acquired by the image forming apparatus 102, etc., and which is to be processed, in a storage means such as, for example, the storage section 204 of FIG. 2 as document data 408.

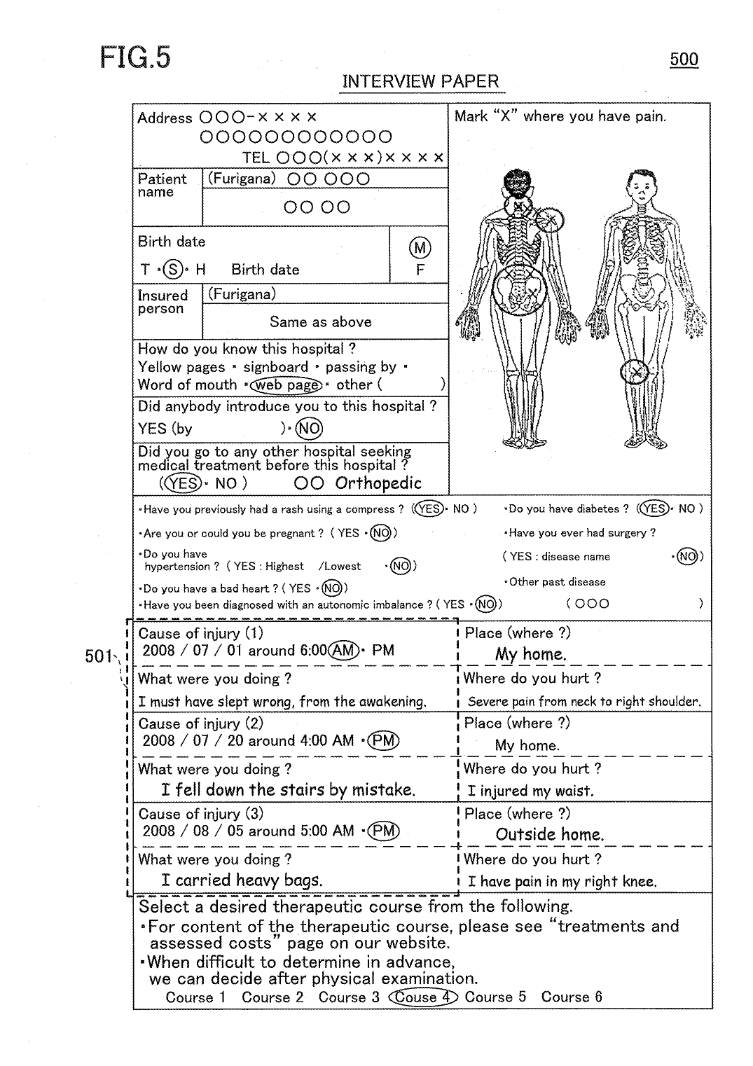

Here, the document (document image) to be processed in the document processing system 100 is described. FIG. 5 illustrates an example of a document according to an embodiment. In FIG. 5, in an interview paper 500 which is one example of the document, questions are printed in type (typed letters) and answers can be handwritten in the fill-in ranges (entry columns) corresponding to the questions. In this embodiment, for example, like this interview paper 500, a process is performed on a document where, for example, handwritten characters, etc., are written in fill-in ranges (fill-in paper) according to the respective instructions, printed in type in advance, describing what is to be written in the fill-in ranges. In other words, a document which includes predetermined one or more character strings (typed texts) and fill-in ranges (entry columns), where handwritten characters are written, corresponding to the fill-in ranges is the processing target. Here, note that the interview paper 500 is an example only. The present invention may also be applied to a document having other formats such as, for example, a handwritten ledger paper, a check result entry book, etc., where, for example, handwritten characters, etc., are written in fill-in ranges (fill-in paper) according to the respective instructions, printed in type in advance, describing what is to be written in the fill-in ranges.

Referring back to FIG. 4, the functional configuration of the server apparatus 101 is further described. The association information storage means 403 stores a predetermined one or more character strings (typed texts) of a document image to be processed in association with fill-in ranges (entry columns) of handwritten characters, etc., the fill-in ranges corresponding to the character strings in the document image to be processed into a storage means such as the storage section 204 of FIG. 2 as association information 409, etc.

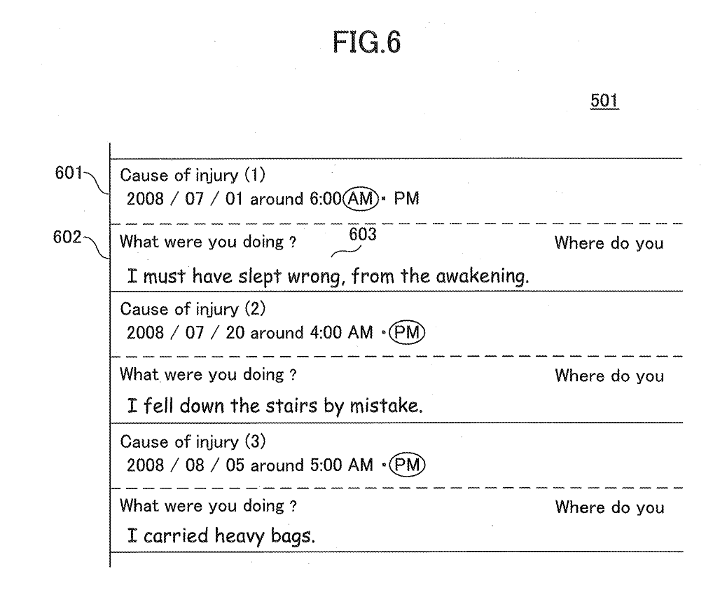

FIG. 6 is an enlarged view of the example of the document according to an embodiment. FIG. 6 is a view of an enlarged area 501 of the interview paper 500 of FIG. 5. In FIG. 6, in response to a typed question 602 “what did you doing ?”, the answer 603 “I must have slept wrong, and from the awakening” is written in handwritten characters. In this case, as the association information 409, the characters string of the typed question 602 “what did you doing ?” is stored in association with a fill-in range (entry column) where the answer 603 is written in handwritten characters corresponding to the characters string of the question 602.

Referring back to FIG. 4, the functional configuration of the server apparatus 101 is further described. The identification means 404 identifies the fill-in ranges corresponding to the character strings (typed texts, etc.) stored as (in) the association information 409 based on, for example, the document image, etc., which is read by the image forming apparatus 102, etc., (identification process). Further, the identification means 404 may identify the character strings (typed texts) included in a document image and the fill-in ranges corresponding to the character strings. The content of the identification process is described below.

The search-for means 405 searches for a character string which includes a searched-for character string, requested (input) to the terminal device 103, etc., from among the character strings stored as (in) the association information 409. In the association information 409, the character strings (typed texts) are stored in association with the corresponding fill-in ranges (entry columns) where handwritten characters, etc., are to be written. Due to this, it becomes possible to identify the fill-in range which corresponds to the question, etc., including the searched-for character string as a result of searching.

The display control means 406 displays a list of images of the fill-in ranges, for example, on the terminal device 103, etc., the fill-in ranges corresponding to the character strings which are searched-for by the search-for means 405, and being in the document image stored (accumulated) as the document data 408. For example, in the document image of FIG. 6, in a case where the question “what did you doing ?” is designated as the searched-for character string, there are three character strings which correspond to the searched-for character string “what did you doing ?” in the document image of FIG. 6. In this case, the display control means 406 displays a list of images of the fill-in ranges, where the answers “I must have slept wrong, and from the awakening”, “I fell down the stairs”, and “I carried heavy bags” are described, on the terminal device 103, etc.

The extraction means 407 extracts an image of an input range (fill-in range) corresponding to the handwritten characters selected from among the handwritten characters displayed in a list on the terminal device 103, etc. The display control means 406 displays the image extracted by the extraction means 407 in a list, for example, on the terminal device 103, etc.

Note that the document storage means 402, the association information storage means 403, the identification means 404, the search-for means 405, the display control means 406, the extraction means 407, etc., are realized by a program running, for example, in the server apparatus 101.

### Functional Configuration of the Image Forming Apparatus 102

In FIG. 4, the image forming apparatus 102 includes a reading means 410, a character recognition means 411, an input display means 412, a communication means 413, etc.

The reading means 410 reads a document to be processed, and converts the read document into electronic data such as a document image, etc. The reading means 410 includes, for example, the scanner 312 of FIG. 3, a control program thereof, etc.

The character recognition means 411 performs an Optical Character Recognition (OCR) process that converts character images included in the document image, etc., read by the reading means 410 into text data, and acquires the character strings (typed texts) included in the document image and the coordinates information of the character strings. The character recognition means 411 is realized by, for example, a program running on the CPU 301 of FIG. 3, etc.

The input display means 412 displays various information and receives user's input operations, and includes, for example, the operation panel 309 of FIG. 3 and the control program thereof. The input display means 412 may be separated into an input means and a display means.

The communication means 413 connects the image forming apparatus 102 to the network 104 so that the image forming apparatus 102 can perform data transmission and reception with the server apparatus 101, the terminal device 103, etc. The communication means 413 corresponds to, for example, the NIC 313 of FIG. 3.

### Functional Configuration of the Terminal Device 103

In FIG. 4, the terminal device 103 includes an input means 414, a display means 415, and a communication means 416.

The input means 414 inputs a user's input operation, and corresponds to, for example, the input section 206 of FIG. 2.

The display means 415 displays various information of processing screens, etc., of the terminal device 103, and corresponds to, for example, the display section 207 of FIG. 2. Further, the display means 415 displays, for example, a list display screen of the images based on an instruction from the display control means 406 of the server apparatus 101.

The communication means 416 connects the terminal device 103 to the network 104, so that the terminal device 103 can perform data transmission and reception with the server apparatus 101, the image forming apparatus 102, etc., and corresponds to, for example, the communication I/F 208 of FIG. 2.

Note that the above functional configurations are one example only, and the present invention is not limited to the above functional configurations. For example, those means of the server apparatus 101 may be included in the image forming apparatus 102, the terminal device 103, etc. Further, the character recognition means 411, the input means 414, the display means 415, etc., may be included in the server apparatus 101. Further, for example, the image forming apparatus 102 may be connected to the server apparatus 101, the terminal device 103, etc., via a USB interface, etc., without using the communication means 413.

### Identification Process

Here, the process is described of identifying the one or more character strings (typed texts, etc.) included in a document image and the fill-in ranges, where handwritten characters are written, corresponding to the character strings.

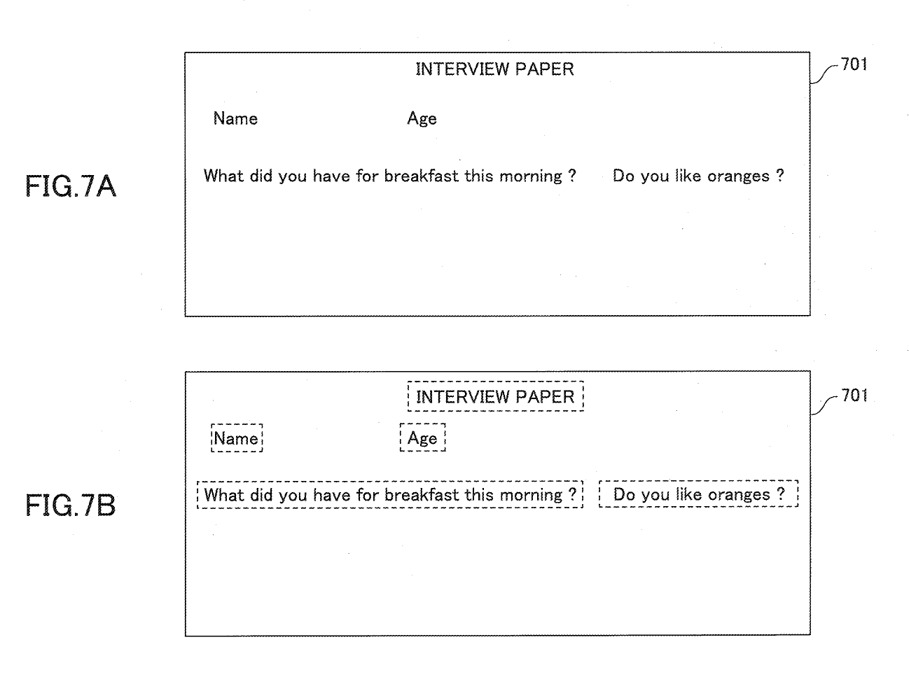

FIGS. 7A and 7B schematically illustrate a type OCR process according to an embodiment. FIG. 7A illustrates an example of an interview paper 701 which is simplified by deleting unnecessary parts to be describes herein according to an embodiment. The interview paper 701 of FIG. 7A is an example of a document which includes the predetermined one or more character strings (typed texts) and the fill-in ranges (not shown), where handwritten characters are written, corresponding to the character strings, and which is to be processed by the document processing system 100.

FIG. 7B illustrates a state where an OCR process is performed by the character recognition means 411 on the document image which is generated (formed) by reading the interview paper 701 of FIG. 7A by using the reading means 410 of the image forming apparatus 102. In FIG. 7B, the ranges surrounded by dotted lines indicate the positions of the typed texts identified by the character recognition means 411. The character recognition means 411 identifies the positions of the typed texts surrounded by the dotted lines, and converts the typed texts into text date such as character coded.

The document data read by the reading means 410, the positions of the typed texts identified by the character recognition means 411, and the text data are transmitted to the server apparatus 101 by the communication means 413 of the image forming apparatus 102.

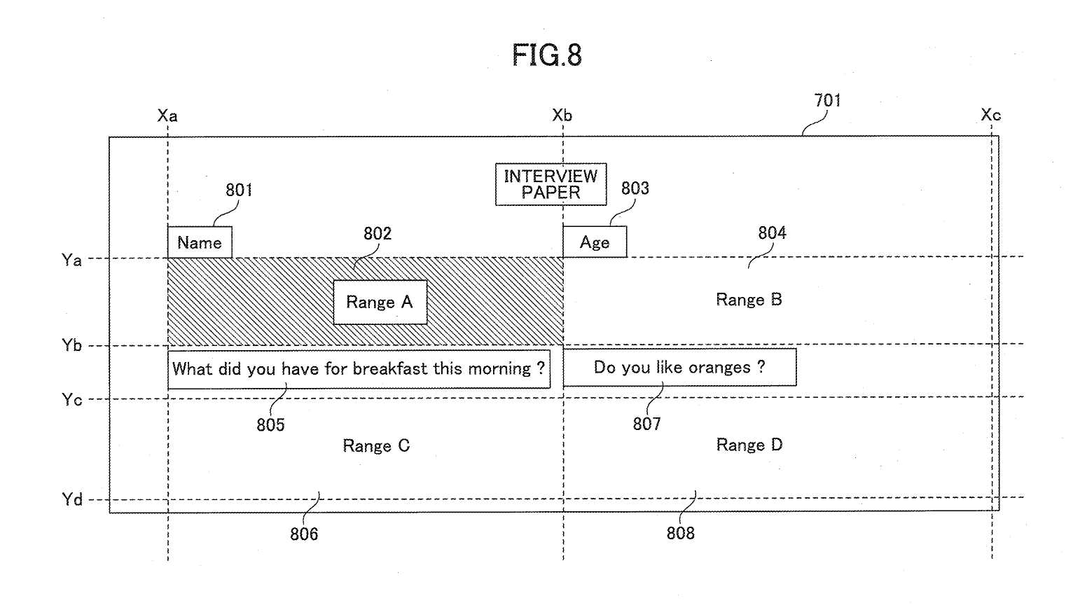

FIG. 8 illustrates the process of identifying the fill-in ranges according to an embodiment. When the server apparatus 101 receives the document data, the positions of the typed texts, the text data, etc., from the image forming apparatus 102, the corresponding relationship between the typed texts and the fill-in ranges, where handwritten characters, etc., are written, corresponding to the typed texts by the identification means 404.

For example, in the interview paper 701 of FIG. 8, it is thought that the handwritten fill-in ranges exist in a range (area) other than the areas where the typed texts 801, 803, 805, 807, etc., exist. Further, in a case where the typed texts 801 are horizontally written, it is thought that the range A802, which is the handwritten fill-in range corresponding to the typed texts 801 is positioned under the typed texts 801. On the other hand, in a case where the typed texts 801 are vertically written, it is thought that the range A 802, which is the handwritten fill-in range corresponding to the typed texts 801 is positioned on the left side of the typed texts 801.

Further, for example, it is assumed that a shape of the handwritten fill-in range corresponding to the typed texts is rectangular and the handwritten fill-in range does not overlap with the typed texts and other handwritten fill-in ranges.

For example, under such conditions, it becomes possible to identify the range A 802 which is hatched with slash lines as the handwritten fill-in range corresponding to the typed texts “Name”. For example, the range A 802 can be defined by the coordinates (Xa,Ya), which is designated by the position of the typed texts 801, and the coordinates (Xb,Yb) which is designated by the positions of the typed texts 803 and 805.

Further, in a cases of a range C 806 and a range D 808 of FIG. 8 where there are no typed texts thereunder (or thereupper), by adding a condition to limit the height of the handwritten fill-in range, etc., it becomes possible to identify the range C 806 and the range D 808. Further, in a cases of a range B 804 and a range D 808 of FIG. 8 where there are no typed texts on the right (or left) side, by adding a condition to limit the width of the handwritten fill-in range, etc., it becomes possible to identify the range B 804 and the range D 808.

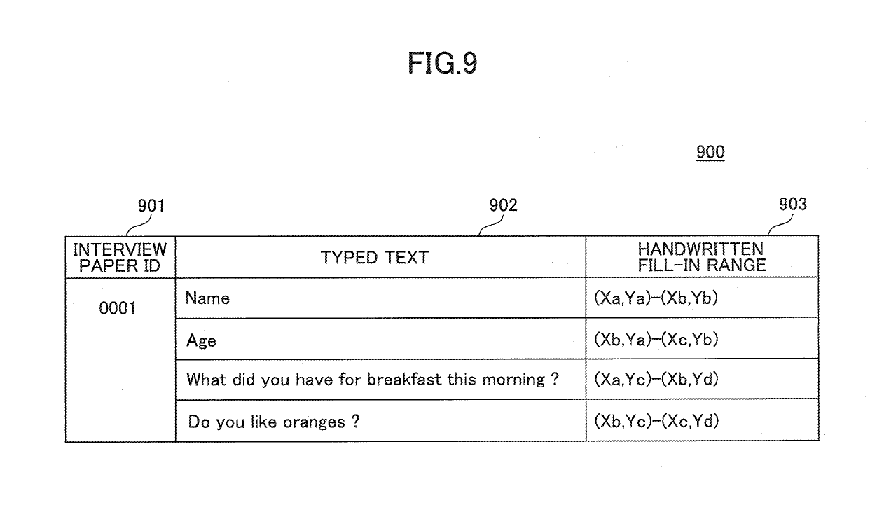

FIG. 9 illustrates an example template according to an embodiment. A template 900 includes information items indicating an interview paper ID 901, the typed texts 902, the handwritten fill-in range 903, etc.

The interview paper ID 901 is identification information to identify the interview paper. The information of the typed texts 902, the handwritten fill-in range 903, etc., may differ depending on the interview sheet. Therefore, the type of the interview paper is managed based on the interview paper ID 901.

Further, the template 900 stores (includes) the typed texts 902 in association with the handwritten fill-in range 903, which area identified by the identification means 404. The template 900 is stored in a storage means such as the storage section 204 of FIG. 2.

### Processing Flow

### Template Registration Process

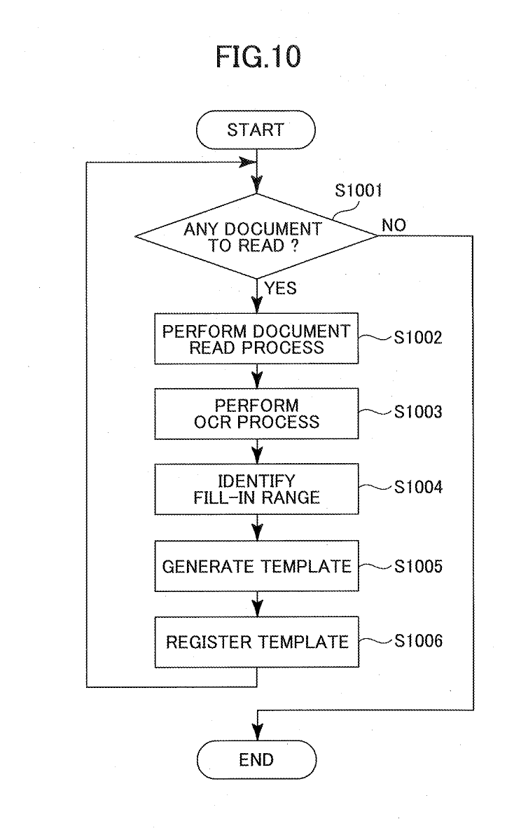

FIG. 10 is a flowchart of an example template registration process according to an embodiment. A user can register the template 900 by causing the image forming apparatus 102 to read, for example, an interview paper, etc., where no data (characters, etc.) are written (by a user).

In step S1001, it is determined whether there exists an interview paper, etc., where no data (characters, etc.) are written, so that a new template 900 is registered (generated) based on the interview paper, etc. When it is determined that there exists the interview paper, etc. (YES in step S1001), the process goes to step S1002. On the other hand, when there is no ledger paper, etc., to be registered as a new template 900 (NO in step S1001), the process ends. Here, note that the interview paper is an example of a document to be processed. For example, the document may be a ledger paper or the like.

In step S1002, the reading means 410 reads the interview paper where no data (characters, etc.) are written, and converts the read data into image data.

In step S1003, the character recognition means 411 performs an ORC process on the image data acquired by the reading means 410 so as to acquire the character codes (text data) and positions (coordinates, etc.) of the typed text.

In step S1004, based on the character codes and the positions of the typed text acquired by the character recognition means 411, the identification means 404 identifies the fill-in ranges where hand-written characters, etc., are to be written.

In step S1005, the identification means 404 generates the template 900 as illustrated in, for example, FIG. 9 based on the character codes of the typed text acquired in step S1003 and the fill-in ranges, where hand-written characters, etc., are to be written, corresponding to the typed text identified in step S1004.

In step S1006, the template 900 generated by the identification means 404 is stored in a storage means such as the storage section 204 of FIG. 2.

The above process is repeated until no interview paper to be registered is left.

In the above description, a case is described where a template is generated by using an interview paper where no (before) characters (characters, etc.) are written. However, note that it is also possible to generate a template by using an interview paper where characters (characters, etc.) are already written. In this case, in step S1003, the typed text (typed characters) and the handwritten characters are distinguished from each other, so that (only) the distinguished typed text can be processed.

In this case, it is possible to distinguish the handwritten characters from the typed text by, for example, using a characteristic that a confidence rating score of recognizing the characters becomes lower when handwritten characters are recognized by the OCR process. Further, it is possible to determine that the handwritten characters are written when the confidence rating score of recognizing the characters is lower than a predetermined threshold value. In this regard, a recognition result where the confidence rating score of recognizing the characters is low indicates that there is high likelihood that characters are wrongly recognized. Therefore, it is not appropriate to use the text (characters) having a low confidence rating score as the text to be searched for, so that it is desired (convenient) not to use such a result (text) to, for example, avoid wasteful searching.

By performing the process described above, it becomes possible to register the template 900 in the document processing system 100 by using, for example, an interview paper where no data (characters, etc.) are written or an interview paper where data (characters, etc.) are written.

### Storage (Accumulation) Process on Document Information

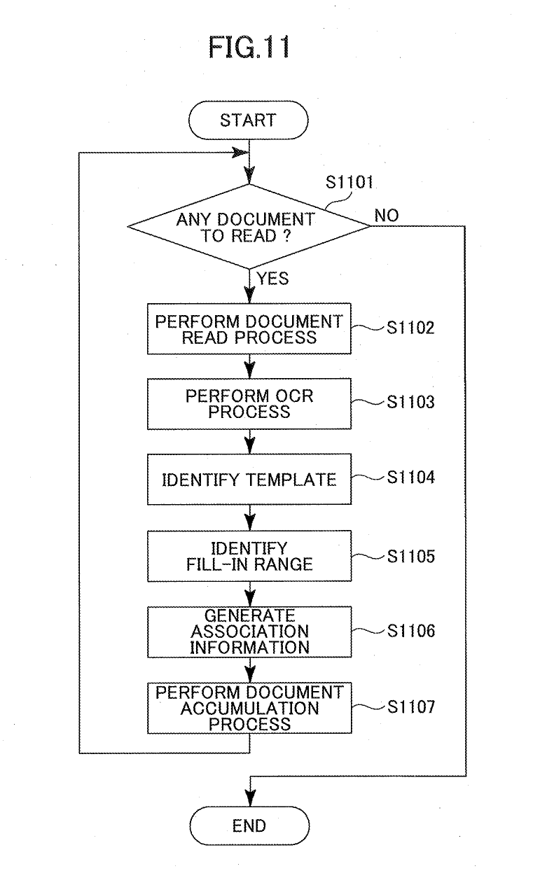

FIG. 11 is a flowchart of an example storage process performed on document information according to an embodiment. In the process, a user can store (accumulate) the document information (document image) in the server apparatus 101 or the like by causing the image forming apparatus 102 to read, for example, the interview paper where data (characters, etc.) are written.

In step S1101, it is determined whether there exists, for example, an interview paper, where data (characters, etc.) are written, to be newly stored. When it is determined that such an interview paper exists (YES in step S1101), a document ID is updated and the process goes to step S1102. On the other hand, when it is determined that no such interview paper exists (NO in step S1101), the process ends. Here, the document ID herein refers to identification information to identify the document image, so that different values are assigned (allocated) to different document images. Further, note that the interview paper is an example only. For example, the document image may be, for example, another ledger paper.

In step S1102, the reading means 410 reads the interview paper where data (characters, etc.) are written, and converts the read data into image data.

In step S1103, the character recognition means 411 performs the ORC process on the image data acquired by the reading means 410 so as to acquire the character codes (text data) and positions (coordinates, etc.) of the typed text. In this case, the character recognition means 411 may distinguish typed text from handwritten characters, so that the ORC process is performed only on the typed text. Otherwise, the character recognition means 411 may perform the ORC process without distinguishing the typed text from the handwritten characters.

In step S1104, for example, the identification means 404 makes a comparison between the recognition result of the typed text by the character recognition means 411 (typed text, etc.) and the information of the template 900 (typed text, etc.), so as to determine which template 900 is being used.

As an example method to determine the template 900, it is possible to count the number of appearances of the character codes and words in each of the documents to be compared. In this method, when the acquired (counted) number of appearances are regarded as the respective dimensions of a vector, the characteristics of the documents can be expressed by using the respective vectors, so that a likelihood degree between two documents to be compared can be acquired based on the Euclidean distance between the vectors. Therefore, it is possible to determine (regard) the template 900 that has the shortest Euclidean distance to the vector acquired based on a document to be identified among a plurality of templates 900 as the template 900 of (corresponding to) the document to be identified. Further, in addition to the number of appearances, with the existing positions of the characters, it become possible to identify the template 900 more accurately. Note that the method of determining the template 900 described above is an example only. Any other appropriate method of determining the template 900 may be alternatively used.

In step S1105, based on the template 900 determined in step S1104, the identification means 404 identifies the handwritten fill-in ranges of the image acquired by the reading means 410.

In step S1106, based on the identified handwritten fill-in ranges in step S1105, the identification means 404 generates the association information 409 of the image acquired by the reading means 410 in a format similar to that of the template 900 of FIG. 9. In the association information 409, the document ID, which is described in step S1101, may be stored in place of the interview paper ID 901 of the template of FIG. 9. Further, the information such as the typed text 902 and the handwritten fill-in range 903 may be stored in the association information 409 similar to the template 900 of FIG. 9.

In step S1107, the association information storage means 403 stores the association information 409, which is generated by the identification means 404, in a storage means such as the storage section 204, etc. Further, the document storage means 402 stores the image data, which are acquired by the reading means 410, in association with the association information 409 in a storage means such as the storage section 204, etc., as the document data 408. Here, the document data 408 are associated with the association information 409 based on, for example, the document ID, etc.

By performing the process describe above, a user can store (accumulate) the document data 408 such as an interview paper, where data (characters, etc.) are written, and the association information 409 in the document processing system 100.

### Searching for Process

A user can use terminal device 103, etc., to browse necessary information from the document images stored in the document processing system 100.

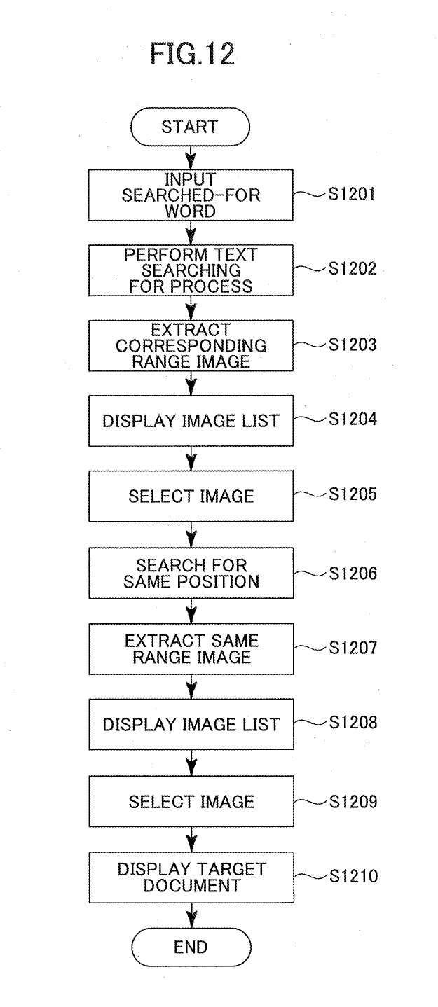

FIG. 12 is a flowchart of an example document display process according to an embodiment.

In step S1201, a user inputs a searched-for word (searched-for character string).

In step S1202, the search-for means 405 searches for the character string which includes or corresponds to the input searched-for character string from among the character strings stored in the association information 409.

In step S1203, the display control means 406 extracts an image of the handwritten fill-in ranges corresponding to the character string which is searched for by the search-for means 405. In step S1204, the display control means 406 displays the extracted image on the terminal device 103 or the like. In this case, the display control means 406 may reduce the size of the image to obtain an excellent small list display (e.g., thumbnail display).

In step S1205, a user is prompted to choose an image from the list display, so that an image is selected by the user.

Here, for example, in a case where there are plural document images having different interview paper IDs in the document processing system 100, in step S1205, the document image is searched for having the same interview paper ID 901 as that of the selected image.

In step S1207, an image is extracted that is included in the document image extracted in step S1206 and that is the image of the fill-in range which is the same as that of the image selected in step S1205.

In step S1208, the display control means 406 displays the images extracted in step S1207 in a list display. In this case, the size of the images may be reduced to obtain an excellent small list display (e.g., thumbnail display).

In step S1209, for example, a user of the terminal device 103 is prompted to choose an image, so that an image is selected by the user.

In step S1210, an (overall) document image including the image selected by the user in step S1209 is displayed on the terminal device 103, etc.

Here, as one example of a specific searching for process, a process is described in a case where an interview paper where a specific person has written data (characters, etc.) is searched for.

For example, in order to see the name of the person who wrote an interview paper, a user inputs a character string “name” as the searched-for word by using the input means 414 of the terminal device 103. In response to the input, the display means 415 of the terminal device 103 display a list including not only an image of the handwritten characters written in the “name” column of the interview paper but also, for example, an image of the handwritten characters written in a question column including the character string “name”. The process corresponds to steps S1201 through S1204 of FIG. 12.

Next, the user selects an image, which corresponds to the “name” column of the interview paper, by using the input means 414 or the like from among the images displayed in the list by the display means 415, so that the display means 415 displays only a list of the handwritten character images of the “name” column of the interview paper. The process corresponds to steps S1205 through S1208 of FIG. 12.

Then, the user selects an image where the name of the specific person is handwritten from among the images in the list displayed by the display means 415. By doing this, the overall image of the interview paper including the selected image is displayed on the display means 415. The process corresponds to steps S1209 and S1210 of FIG. 12.

According to an embodiment, by, for example, doing as described above, it becomes possible to digitize the document, etc., including handwritten characters written in a predetermined format, so that the document, etc. can be used easily.

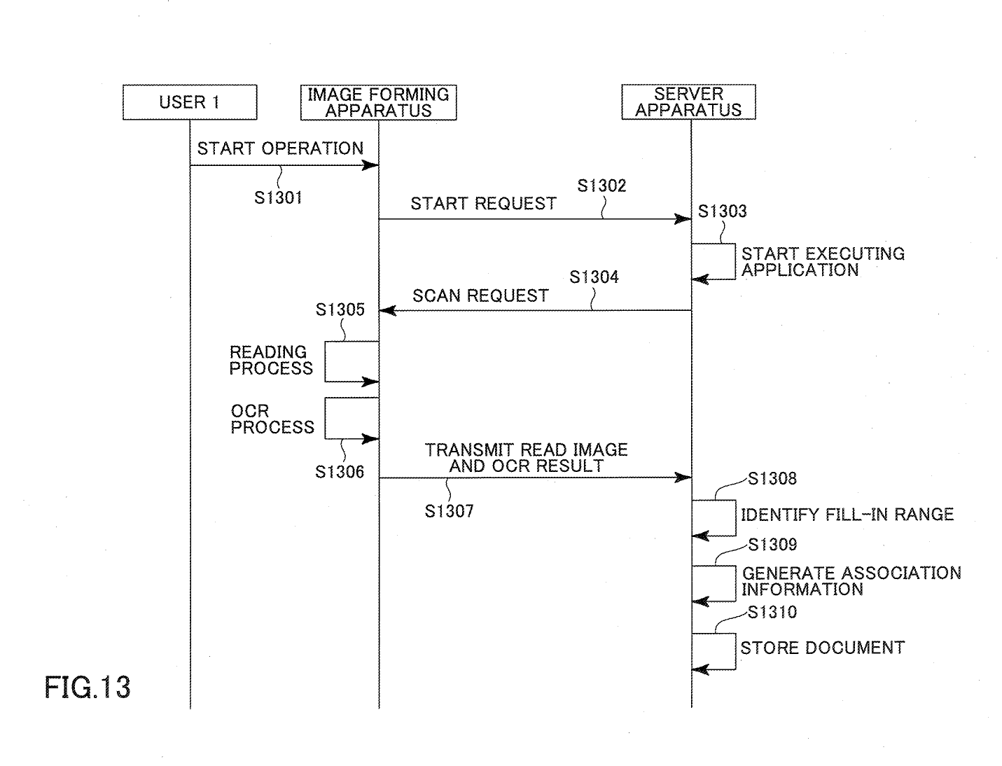

FIG. 13 is a sequence diagram of an example storage (accumulation) process of the document information according to an embodiment.

A user 1, who will store (accumulate) a document image in the document processing system 100, performs a predetermined operation by, for example, using the image forming apparatus 102 (step S1301). In response, the image forming apparatus 102 sends a start request to the server apparatus 101 (step S1302).

Upon receiving the start request, the server apparatus 101 starts, for example, execution of an application (step S1303). By the application, the server apparatus 101 sends a scan request to the image forming apparatus 102 to scan a document (step S1304).

Upon receiving the scan request, the image forming apparatus 102 reads (scans) the document (step S1305), and performs an OCR process on the read image data (step S1306). Further, the image forming apparatus 102 transmits the acquired document image and a result of the OCR process (i.e., text data, coordinate information, etc.) to the server apparatus 101 (step S1307).

Upon receiving the document image and the result of the OCR process from the image forming apparatus 102, the server apparatus 101 identifies the fill-in range by using the identification means 404 (step S1308), generates the association information 409 including the character string in association with the fill-in range (step S1309), and stores the association information 409. Further, the document storage (accumulation) means 402 performs a document storage (accumulation) process that stores document data 408 received from the image forming apparatus 102 (step S1310). Here, note that the OCR process (step S1306) of FIG. 13 may be performed by the server apparatus 101.

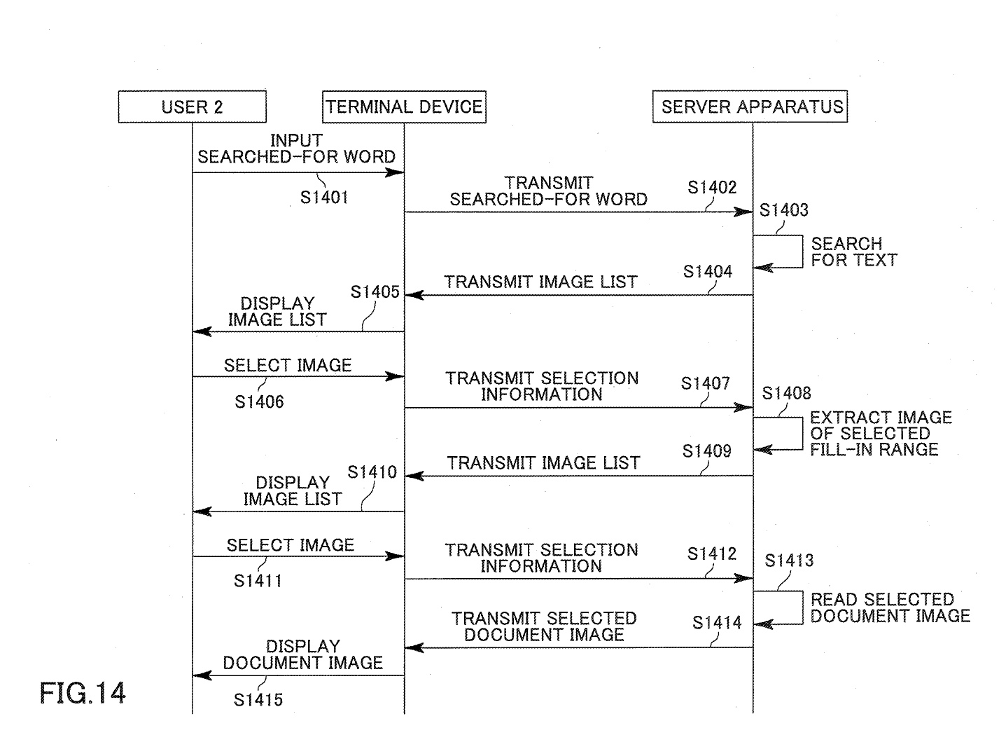

FIG. 14 is a sequence diagram of an example searching for process of the document information according to an embodiment.

A user 2, who will perform searching in the document processing system 100, inputs a searched-for word (searched-for character string) by using, for example, the terminal device 103 (step S1401). Here, it is assumed that, for example, a program corresponding to the document processing system 100 runs in the terminal device 103. When the searched-for word is input, the terminal device 103 transmits the searched-for word to the server apparatus 101 (step S1402).

Upon receiving the searched-for word, the server 101, the search-for means 405 of the server apparatus 101 performs a text searching for process to search for the text (step S1403), and transmits an image list, which is based on a result of the searching for process, to the terminal device 103 (step S1404).

The terminal device 103 causes the display means 415 to display a list of the received images (step S1405), and prompts the user 2 to select an image. When the user 2 select an image (step S1406), the terminal device 103 transmits information of the selected image to the server apparatus 101 (step S1407).

Upon receiving the information of the selected image, the server apparatus 101 extracts images of the fill-in range which is the same as the fill-in range in the selected image in the document image having the same interview paper ID, etc., of the selected image (step S1407), and transmits the list of the extracted images to the terminal device 103 (step S1409).

The terminal device 103 causes the display means 415 to display a list of the received images (step S1410), and prompts the user 2 to select an image. When the user 2 selects an image (step S1411), the terminal device 103 transmits information of the selected image to the server apparatus 101 (step S1412).

Upon receiving the information of the selected image from the terminal device 103, the server apparatus 101 reads the document image including the selected image (step S1413), and transmits the selected document image to the terminal device 103 (step S1414).

The terminal device 103 displays the document image, which is received from the server apparatus 101, on the display means 415 (step S1415).

By doing this, the user 2 can browse a desired document image with a simple operation.

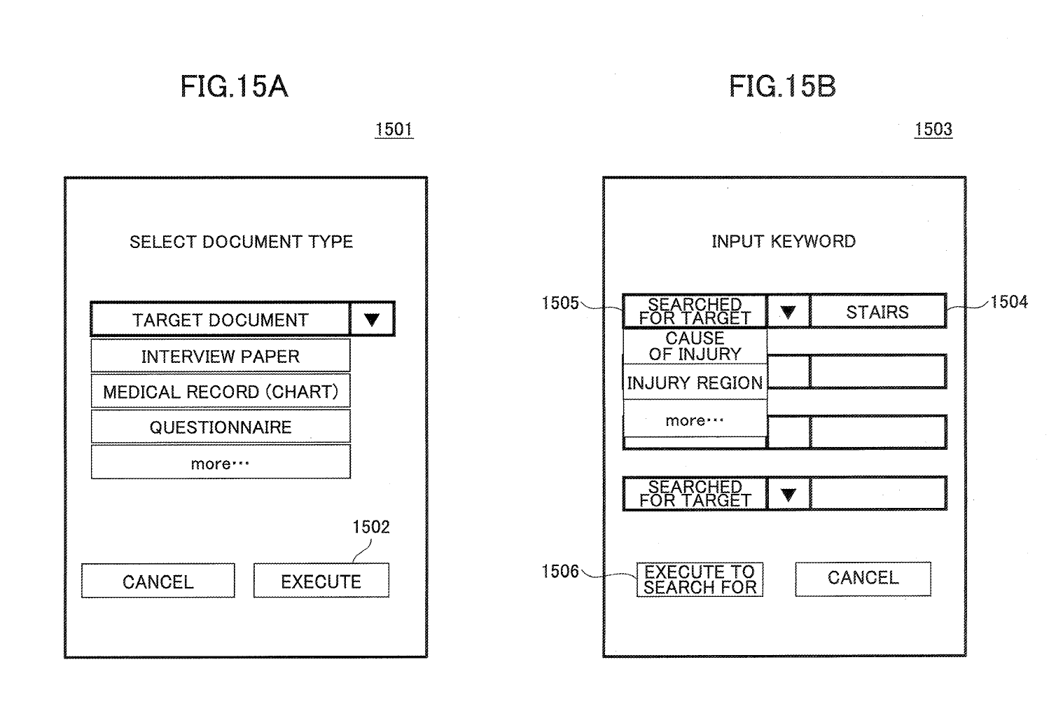

Next, with reference to FIGS. 15A through 17, a transition of the display screen of the terminal device 103 when the process of FIG. 14 is performed.

### Example Display Screens

### Examples of Display Screens

FIGS. 15A and 15B illustrate example input screens to input a searched-for word according to an embodiment. In step S1401 of FIG. 14, the terminal device 103 displays a screen 1501 as illustrated in FIG. 15A. The screen 1501 of FIG. 15A displays types of a document image in a manner such that the type can be selected. Here, the term “type of the document image” refers to, for example, the interview paper, a medical record (chart), a questionnaire, etc. When a type of the document image is selected in the screen 1501 of FIG. 15A and an “Execute” button is pressed, the terminal device 103 displays a screen 1503 as illustrated in FIG. 15B.

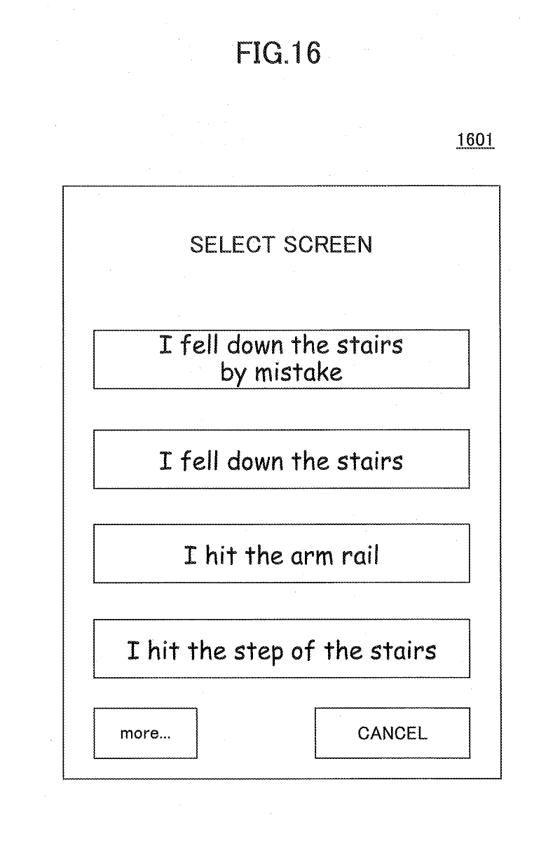

The screen 1503 of FIG. 15B displays an input column 1504 to input a keyword and further displays a search target item 1505 in a selectable manner. When a keyword is input and a “Search Execute” button is pressed in the screen 1503 of FIG. 15B, the terminal device 103 performs a process of a “searched-for word transmission” which is illustrated in step S1402 of FIG. 14. Then, when the image list is received in step S1404 of FIG. 14, the terminal device 103 displays a screen 1601 as illustrated in FIG. 16 (step S1405 of FIG. 14).

FIG. 16 illustrates an example display screen of the image list according to an embodiment. The screen 1601 of FIG. 16 displays a list of received images. As the list of images, a list of the screens may be displayed, in which the screens are arranged like icons, each of the screens illustrating the entire image as illustrated in FIG. 5. However, when the screen size of the terminal device 103 is small, it may become difficult to determine which of the screens is to be selected even when the screens of the same format are arranged on the screen. Therefore, for example, it is preferable that a list is displayed in which each of the screens in the list includes only an extracted part where the searched-for word is included as illustrated in FIG. 16.

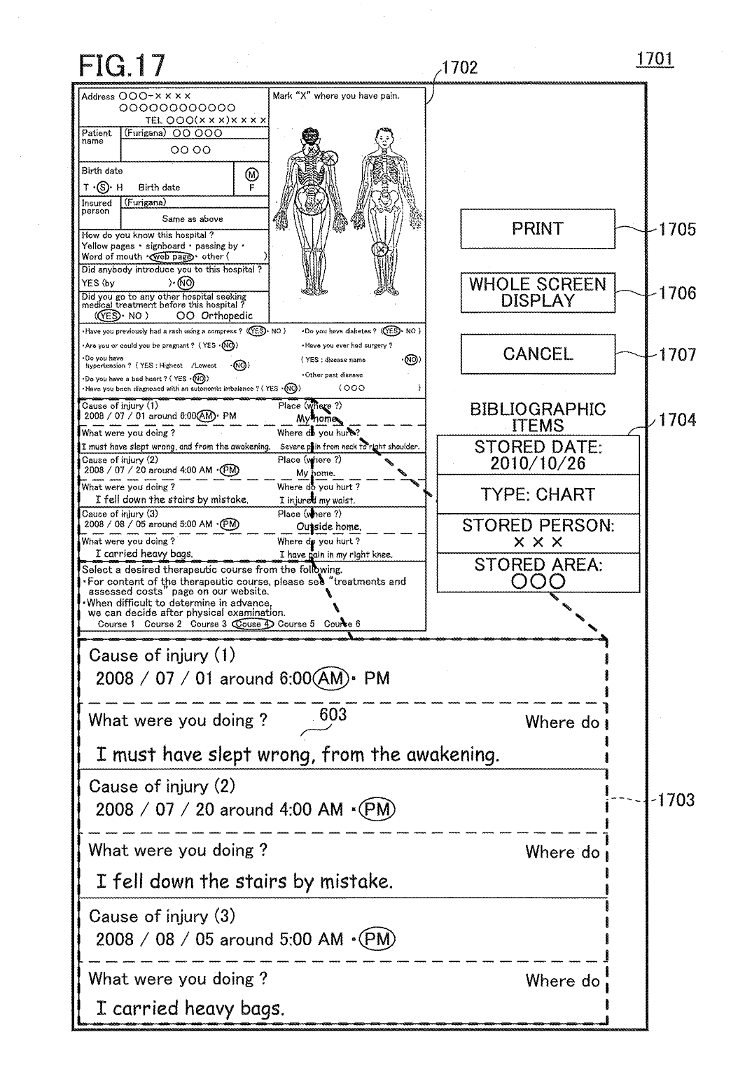

When one screen is selected in the screen 1601 of FIG. 16 (step S1411 in FIG. 14), the terminal device 103 transmits information of the selected image (performs a “selected information transmission” process) in step S1412 of FIG. 14. Then, upon receiving the document image which is selected in step S1414 of FIG. 14, the terminal device 103 displays a screen 1701 as illustrated in FIG. 17 (step S1415).

FIG. 17 illustrates an example display screen of the document image according to an embodiment. The screen 1701 of FIG. 17 displays a display screen based on the received document image. The terminal device 103 displays an entire document image 1702 in the upper left part of the screen 1701. Further, in the lower part of the image 1701, the terminal device 103 displays an image 1703 in which a part including the searched for keyword(s) in the entire image is enlarged. Further, on the right upper part of the image 1701, the terminal device 103 displays bibliographic items 1704 and buttons to be selected to perform respective processes on the image. The buttons to select the respective processes include, for example, a “Print” button 1705, a “Whole Screen Display” button 1706, a “Cancel” button 1707, etc.

When the “Print” button is selected, the terminal device 103 transmits a print request to print the displayed document image to the server apparatus 101. In accordance with the received print request, the server apparatus 101 transmits a print instruction to print the document image to the image forming apparatus 102. The image forming apparatus 102 perform printing based on the received print instruction.

When the “Whole Screen Display” button 1706 is displayed, the terminal device 103 displays the document image by using the entire screen. When the “Cancel” button 1707 is selected, the terminal device cancels the current process, and, for example, displays the input screens to input a searched for word as illustrated in FIGS. 15A and 15B.

As described above, in the document processing system 100 according to an embodiment, it becomes possible to digitize the document, etc., including handwritten characters written in a predetermined format, so that the document, etc. can be used easily.

### Other Embodiments

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

For example, in the above embodiment, as described with reference to FIG. 8, a method is described where the handwritten fill-in range corresponding to the typed text is identified based on the position of the typed text. However, there may be a case where it is difficult to apply the method as described with reference to FIG. 8 when an interview paper and a ledger paper have a more complicated layout (format). In such a case, the document processing system 100 may have a means that sets the handwritten fill-in range and associates the handwritten fill-in range with the typed text by, for example, a user's operation.

In this case, for example, in FIG. 8, the coordinates (Xa, Ya) and (Xb, Yb) which indicate the rectangular range A 802 indicating the handwritten fill-in range are input by a user's operation. Further, in order to associate the input coordinate range with the corresponding typed text, the user may input both the input coordinate range and arbitrary coordinates within the range of the typed text. Further, as an example method of enhancing the expression, the handwritten fill-in range is indicated as a rectangular shape using dotted lines and the associated type text is indicated by using a dotted arrow.

Further, the document processing system 100 may be, for example, a document processing apparatus that is realized by a program running in the image forming apparatus 102, the terminal device 103, etc.

What is claimed is:

1. A document processing system comprising:
a document storage unit configured to store document images which include a predetermined one or more character strings and one or more fill-in ranges which correspond to the one or more character strings;
an association information storage unit configured to store the character strings of the document images in association with the fill-in ranges corresponding to the character strings;
a searching for unit configured to search for a character string, which includes a requested searched-for character string, from among the stored character strings; and
a display control unit configured to display a list of images of the fill-in ranges corresponding to the searched for character string of the stored document images.

2. The document processing system according to claim 1, further comprising:
an identification unit configured to identify the fill-in ranges which correspond to the one or more character strings.

3. The document processing system according to claim 2, further comprising:
a character recognition unit configured to acquire the one or more character strings and coordinate information of the one or more character strings,
wherein the identification unit is configured to identify the fill-in ranges based on the acquired coordinate information.

4. The document processing system according to claim 3,
wherein the character recognition unit is configured to acquire the one or more character strings and the coordinate information of the one or more character strings by using a document image where no data are written in the fill-in ranges.

5. The document processing system according to claim 3,
wherein the one or more character strings include typed characters, and the fill-in ranges include handwritten characters, and
wherein the character recognition unit is configured to distinguish the typed characters from the handwritten characters in the document images, and acquire the one or more character strings and the coordinate information of the one or more character strings based on the distinguished typed characters.

6. The document processing system according to claim 1,
wherein the display control unit is configured to, when one image is selected from the list of the images, display a list of images of the fill-in ranges which is a same as in the selected one image of the stored document images.

7. The document processing system according to claim 1,
wherein the display control unit is configured to, when one image is selected from the list of the images, display one or more document images which include the selected image from among the stored document images.

8. The document processing system according to claim 2,
wherein the identification unit is configured to prompt a user to set the one or more character strings of the document images and the fill-in ranges which correspond to the one or more character strings.

9. A document processing apparatus comprising:
a document storage unit configured to store document images which include a predetermined one or more character strings and one or more fill-in ranges which correspond to the one or more character strings;
an association information storage unit configured to store the character strings of the document images in association with the fill-in ranges corresponding to the character strings;
a searching for unit configured to search for a character string, which includes a requested searched-for character string, from among the stored character strings; and
a display control unit configured to display a list of images of the fill-in ranges corresponding to the searched for character string of the stored document images.

10. A document processing method comprising:
a document storing step of storing document images which include a predetermined one or more character strings and one or more fill-in ranges which correspond to the one or more character strings;
an association information storage step of storing the character strings of the document images in association with the fill-in ranges corresponding to the character strings;
a searching for step of searching for a character string, which includes a requested searched-for character string, from among the stored character strings; and
a display control step of displaying a list of images of the fill-in ranges corresponding to the searched for character string of the stored document images.
